(19) United States
(12) Patent Application Publication
(10) Pub. No.: US 2017/0348721 A1
(43) Pub. Date: Dec. 7, 2017

(54) HIGH TEMPERATURE MULTIPHASE INJECTION DEVICE

(71) Applicants: Kamaldeep KALSI, Cambridge (GB); Energy Technologies Institute LLP, Loughborough (GB)

(72) Inventor: Kamaldeep KALSI, Cambridge (GB)

(21) Appl. No.: 15/345,369

(22) Filed: Nov. 7, 2016

(30) Foreign Application Priority Data
Jun. 6, 2016 (GB) 1609850.1

(51) Int. Cl. B05B 15/00; B05B 7/00; B05B 1/14

(52) U.S. Cl. CPC B05B 15/00; B05B 1/14; B05B 7/00

(57) ABSTRACT

The present invention relates to a multiphase injection device suitable for use in a high-temperature process environment, comprising a nozzle and a plurality of passageways in the nozzle, wherein the plurality of passageways comprises a primary passageway and at least one secondary passageway. The passageways are operable to simultaneously inject respective process media into a reactor at different angles relative to each other.

### TECHNICAL FIELD

The present invention relates to a multiphase injection device suitable for use in a high-temperature process environment.

### BACKGROUND

Many industrial chemical reactions involve putting one or more process media (gases, fluids) in a high-temperature and/or high-pressure environment. Examples of such reactions include biomass and waste gasification processes. It is necessary to provide an injection system or device for introducing such process media into the (often highly flammable) process environment in a controlled manner with regard to injection velocity, temperature, etc. Ideally, an injection system or device would both ensure safety and improve and maximise the efficiency and effectiveness of the process.

There are many challenges to developing such an injection device or system that is reliable, effective and durable. For instance, in order to elevate the temperature of the process media in the chemical process and/or instigate other chemical reactions, in some cases oxygen is injected into the process vessel, resulting in extreme local flame temperatures that are too high for conventional metallurgy (e.g. in excess of 2500° C.). This is a highly relevant concern when choosing a material for a nozzle device, as such high temperatures may lead to melting and/or very high nozzle attrition.

The use of ceramic-lined tips can prolong the life of the nozzles but not prevent attrition altogether; the nozzle remains an attrition item, i.e. it degrades due to the very high thermal gradients experienced and has to be replaced regularly.

A conventional fully ceramic nozzle cannot be constructed with the precision required to carry out essential core functionality (e.g. toleration of high temperatures and solid matter, further explained below) and other critical support functions (e.g. installation of safety devices, further explained below). Such a device is also fragile due to the low tensile strength of conventional ceramic media, making it unsuitable for use in process environments where large thermal gradients (e.g. caused by cooling of ceramic nozzles) and significant pressure differences are present or likely to arise.

The most common approach for injecting oxygen into high-temperature chemical processes typically involves large dilution with inert media, as well as nozzles or nozzle parts (e.g. nozzle faces) that are typically replaceable, i.e. consumables that have to be replaced at regular intervals, causing process downtime and large operating costs. Additionally, due to this “disposable” nature, the nozzles are limited in functionality, and safety provisions such as flame detection or pilot lighting cannot be incorporated into the devices.

Notably, conventional devices cannot be utilised to concurrently inject solids into the process as their construction, both in terms of their materials and geometry, does not withstand the level of attrition that is caused by any such solid material. In other words, it has to be ensured that the fluids injected are free of any solids. When ash is present in the process vessel, which is likely when the process involves any gasification or pyrolysis process, high local temperatures can lead to melting of the media, which when interacting with the relatively cooler nozzle tip results in the formation of deposits that ultimately cause failure of the tip itself.

### SUMMARY OF THE INVENTION

The present invention regards a means for the introduction of fluids, or fluids mixed with solids, into processes operating at high pressure and temperature.

In accordance with the invention herein described, there is disclosed a high-temperature injection apparatus, comprising a nozzle and a plurality of passageways in the nozzle, wherein the plurality of passageways comprises a primary passageway and at least one secondary passageway.

Preferably, the apparatus is a multiphase injection device. Preferably, the primary passageway and/or the at least one secondary passageway are operable to inject a fluid, gas or solid. Preferably, the primary passageway is operable to inject a fluid, gas or solid and the at least one secondary passageway is operable to inject a different fluid, gas or solid simultaneously. The solid may be carried within another fluid. It is appreciated that passageways can also be described as channels, ducts or pathways in general for transport of fluids, gases and solids.

Preferably, the nozzle has a longitudinal axis, and is elongated in length in the same direction. Preferably, each passageway extends substantially along the length of the nozzle.

Preferably, some or all of the primary and secondary passageways are operable to inject a fluid, gas or solid from the device at different angles. Preferably, the at least one secondary passageway is operable to inject a fluid, gas or solid at an angle to the longitudinal axis of the nozzle.

Preferably, the plurality of passageways comprise a plurality of secondary passageways arranged about the primary passageway. It is appreciated that the primary and secondary passageways may be described as main and auxiliary passageways respectively. Further, it is appreciated that each of the various passageways can be recognised as primary/main or secondary/auxiliary in different arrangements.

In one aspect of the invention, the fluid, gas or solid comprises at least one of: steam, nitrogen, an oxidant, oxidant media, a catalyst, catalytic media, bed media, sand, and a coolant.

Preferably, the plurality of secondary passageways are arranged as a series of concentric or annular passageways around the primary passageway.

Preferably, the primary passageway is a central passageway aligned with the longitudinal axis.

Preferably, each of the plurality of secondary passageways is operable to inject the fluid, gas or solid at an inward angle with respect to the primary passageway.

Preferably, media transported in some or all of the plurality of passageways of the device do not mix within the device. To this end, the primary passageway and at least one of the plurality of secondary passageways may be isolated from each other, and a first of the plurality of the secondary passageways and a second of the plurality of the secondary passageways may be isolated from each other.

Preferably, the device comprises heat exchanging means. To this end, preferably, at least one secondary passageway is adjacent and parallel to the primary passageway or another secondary passageway along a portion of the length of the nozzle.

Preferably, the material of the nozzle comprises advanced ceramics, such as silicon carbide (SiC) and/or SiC-based variants.

Preferably, the device is operable to function in a reducing environment and/or an oxidising environment.

Preferably, the nozzle is disposed in a nozzle casing; the nozzle and/or the nozzle casing may comprise auxiliary equipment or may comprise means for auxiliary equipment to be installed.

Preferably, the apparatus further comprises a dedicated passageway for gas sampling, and/or eductor means.

In accordance with an aspect of the invention, there is disclosed a high-temperature multiphase injection nozzle device for use in a reactor, comprising first and second passageways, wherein at least one passageway is operable to inject solid media into the reactor. The solid media may be carried in a fluid.

In accordance with another aspect of the invention, there is disclosed an injection nozzle and heat exchanger device, comprising a first passageway operable to transport a first fluid, gas or solid, and a second passageway operable to transport a second fluid, gas or solid, wherein the first and second passageways are substantially parallel and adjacent to each other so as to allow heat exchange between the first and second fluid, gas or solid, and the first and second passageways are operable to inject the first and second fluid, gas or solid, respectively, simultaneously in a predetermined direction.

In accordance with one aspect of the invention, there is disclosed a method of injecting media into a reactor at high temperature and high pressure, comprising injecting a first media from a first passageway of a nozzle device and injecting simultaneously a second media from a second passageway of the nozzle device isolated from the first passageway, wherein each of the first and second media comprises a fluid, gas or solid. The first media and the second media may be injected at an angle relative to each other.

In one aspect, the method may further comprise, prior to injection, transferring heat between the first media in the first passageway and the second media in the second passageway, wherein the first and second passageways are adjacent and parallel to each other for a portion of the length of the nozzle device. The injection of the first media and the injection of the second media may be performed at a local temperature greater than 1000° C., more preferably greater than 2500° C. The method may further comprise shrouding the first media with the second media or cooling an external shell of the nozzle device.

In accordance with another aspect of the invention, there is disclosed a method of manufacturing the device of any of the above aspects and features, using 3D printing and/or using material comprising silicon carbide (SiC) and/or SiC-based variants.

In order that the present invention be more readily understood, specific embodiments will now be described in conjunction with the attached drawings.

### BRIEF DESCRIPTION OF THE DRAWINGS

FIG. 1a shows an exemplary nozzle in an isometric view.

FIG. 1b is a magnified view of detail D in FIG. 1a.

FIG. 2a shows a front cross-sectional view of an exemplary nozzle device.

FIG. 2b shows a side (longitudinal) cross-sectional view of the exemplary nozzle of FIG. 2a (section A-A).

FIG. 2c is a magnified view of detail B in FIG. 2b.

### SPECIFIC EMBODIMENTS

In accordance with the present arrangement, the design for an apparatus for the introduction of one or more fluids (including liquids or gases), or fluids mixed with solids, into high-temperature and/or high-pressure environments such as a reactor, is described.

The arrangement, in particular, regards a means such as a nozzle device for introducing oxidants in the form of air, chemical oxygen vectors, or pure oxygen into processes containing flammable environments, whereby the injection process results in spontaneous combustion, either via the formation of a diffusion flame or via flameless combustion.

The nozzle device is typically designed to operate in process environments that contain hydrogen or other similar combustible media, which result in high local flame temperatures. The nozzle device is also operable to inject solids such as catalyst media with varying granulometry into the process environment concurrently with the injected fluid in concentrations approaching a dense phase. Further, the design allows the nozzle device to operate reliably in flows that contain ash or other such solid media which would typically melt at the local nozzle interface, causing deposition or blockage.

In one embodiment, the nozzle device has a design that permits all of the above functionality to be achieved for flameless combustion, in that the oxidant media passing through the device is allowed to be preheated to near-process temperatures using the heat from the process itself—thus acting as a heat exchanger in itself—while maintaining sufficient cooling at the nozzle tips to prolong service life.

In addition to the core functionality described above, the nozzle device as currently disclosed allows a range of other important support functions to be reliably carried out. Examples of auxiliary functions and features to be incorporated into the nozzle device include measurement instruments, flame detection means, pilot lights, and other safety features or instrumentation.

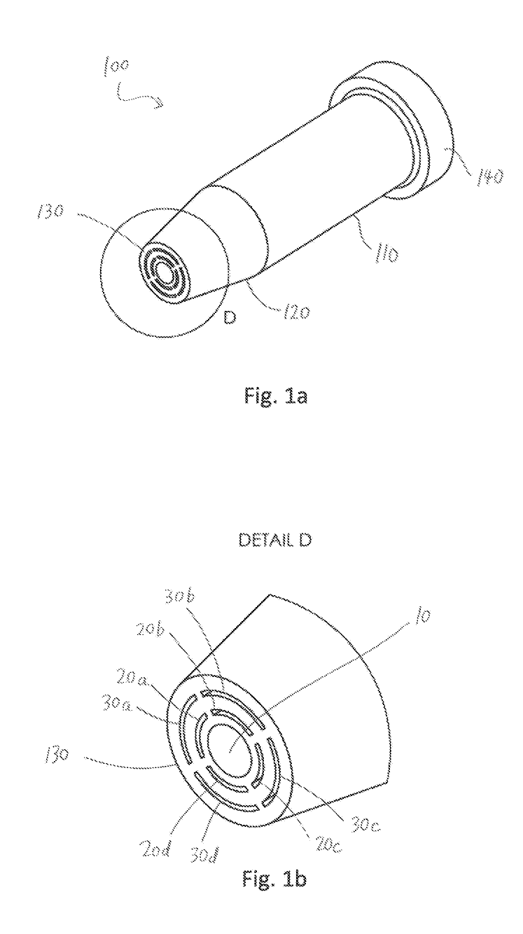

A high-temperature injection apparatus, in accordance to the present arrangement, may comprise a nozzle 100 in which a plurality of passageways are formed. These passageways include a primary passageway 10 and at least one secondary passageway. Preferably, the at least one secondary passageway comprises a plurality of secondary passageways 20a-d, 30a-d FIG. 1a shows an example of such a nozzle. This drawing merely serves as an illustration of an exemplary embodiment in accordance with aspects of the invention, and may have been simplified to aid clear understanding of the invention.

In one embodiment, the nozzle 100 is elongated in shape along a longitudinal axis and has a circular cross-section. Preferably, the primary passageway 10 is a central passageway disposed at the centre of the nozzle along the longitudinal axis. The primary passageway may be circular in cross-section.

Preferably, each of the primary passageway 10 and the one or more secondary passageways 20a-d, 30a-d is operable to inject a fluid, gas or solid (hereafter a process medium) into a reactor or other process environments. Examples of process media include one or any combination of steam, nitrogen, an oxidant or oxidant media, a catalyst or catalytic media, bed media such as sand, coolant(s), and any reactants for the (chemical) reaction(s) taking place in the process environment into which the nozzle device is injecting process media. If a process medium comprises a solid or solids, the solid(s) may or may not be carried in a fluid. Note that the presence of a solids or solids in a process media may or may not be desirable.

Preferably, the passageways (the primary passageway 10 and one or more secondary passageways 20a-d, 30a-d) are operable to inject respective process media simultaneously.

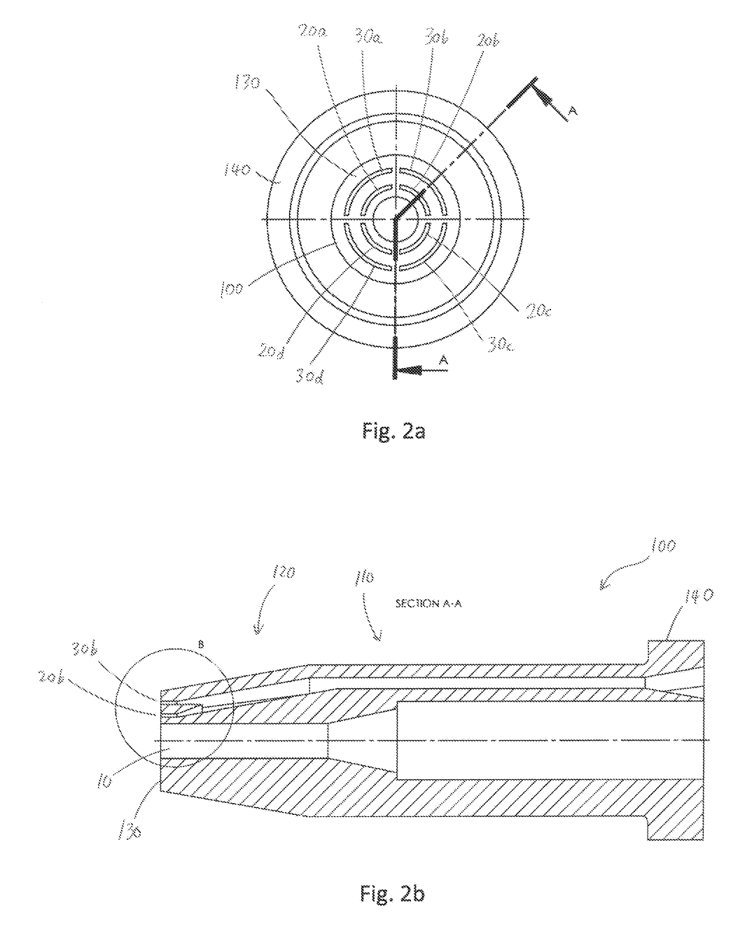

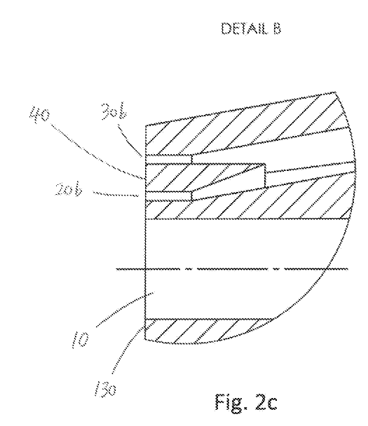

In one preferable embodiment, as illustrated in FIG. 1a, FIG. 1b (which shows a magnified detail D of FIG. 1a) and FIG. 2a, the nozzle 100 includes a plurality of secondary passageways 20a-d, 30a-d arranged about or around the primary passageway 10. In the exemplary design shown, the plurality of secondary passageways 20a-d, 30a-d are arranged as a series of concentric or annular passageways around the primary passageway 10.

In an embodiment, all or some of the passageways (the primary passageway 10 and the one or more secondary passageways 20a-d, 30a-d) may be isolated from each other. For example, each of secondary passageways 20a, 20b, 20c and 20d as shown in FIGS. 1b and 2a are isolated from one another. By preventing the process media present in each respective passageway from mixing within the nozzle device, this design desirably allows the ejection of different process media from different respective passageways of the nozzle device simultaneously (or otherwise). This allows the possibility of performing multiple functions at the same time, as the context requires. Adjacent passageways which are isolated from each other for the above reasons are designed to have the ability to withstand significant pressure differences therebetween. On the other hand, it is also possible for some of the passageways to be interconnected and not isolated for other functional reasons. For example, secondary passageways 20a and 30a may not be isolated from each other.

The nozzle device is generally suitable for use in relation to reactors, chambers or other environments wherein high-temperature reactions take place. It is intended that the injection process via the nozzle device results in spontaneous combustion inside the reactor or chamber into which the media are introduced, either via the formation of a diffusion flame or via flameless combustion.

When used with a diffusion flame, the nozzle device is designed to offset the flame front from the nozzle tip 130 by injecting a vector such as steam which (i) increases the local injection velocity, and (ii) alters the concentration profile of the diffused media, such that the conditions for autoignition occur further away from the nozzle tip.

In one embodiment of the design, one or more of the secondary passageways 20a-d, 30a-d are operable to inject their respective process medium at an angle relative to the longitudinal axis of the nozzle 10 or the primary passageway 100. In the exemplary design as illustrated in FIGS. 1a and 3b, the nozzle comprises a main portion 110 and an end portion 120. The cross-section of the main portion 110 is substantially circular and largely constant; the primary passageway 10 and a plurality of secondary passageways 20a-d, 30a-d run parallel to each other and the longitudinal axis of the nozzle 10. The plurality of secondary passageways 20a-d, 30a-d may be arranged concentrically around the primary passageway 10. The end portion 120 is tapered; its cross-sectional area gradually reduces (in diameter) from the main portion 110 until it reaches the nozzle tip 130, i.e. the end of the nozzle 10 where the process media leaves the nozzle device. The primary passageway 100 remains substantially straight along the central longitudinal axis of the nozzle 10 both in the main portion 110 and the end portion 120, whereas the plurality of secondary passageways 20a-d, 30a-d are angled inwardly relative to the central primary passageway 10 in the end portion 120, with the result that the process media of the secondary passageways 20a-d, 30a-d are ejected at an inward angle relative to the direction of ejection of the process medium of the primary passageway 10, allowing them to meet (and possibly mix) at a point physically located away from the nozzle tip 130. The distance between this point and the nozzle tip 130 will depend on various factors such as the velocity of ejection.

For example, the process medium injected into the reactor from the primary passageway 10 is an oxidant for the chemical process, whilst one or more of the secondary passageways 20a-d, 30a-d inject steam at high speed. This arrangement provides a means to accelerate ejection flow of the process media, achieving the aim as stated above of offsetting the diffusion flame from the nozzle tip 130. Advantageously, this helps to reduce the temperature of the nozzle device.

The current design, with the multiple passageways 10, 20a-d, 30a-d aligned in non-parallel directions at least in a portion of the nozzle device, allows the possibility to inject various high-velocity jets of process media at disruptive angles into the diffusion flame zone, providing a means of enhancing turbulence into the flame zone.

Further, it is also herein disclosed the possibility of including in the design of the nozzle device means for altering the local concentration profile of the process media, for instance means to shroud the process media ejected from the primary passageway, and/or means to dilute some of the process media in a localised manner, so as to offset the diffusion flame as mentioned above. In an example, the localised dilution of oxygen with steam or nitrogen will have the effect of offsetting the flame. In another example, oxygen ejected from the primary passageway 10 can be shrouded by steam ejected from some or all of the secondary passageways 20a-d, 30a-d. Such a steam shroud may be an annular shroud.

In one particular embodiment, illustrated in FIG. 2c, the nozzle device further comprises an optional splitter 40 adjacent to the nozzle tip 130. In this design, the splitter is operable to increase the velocity of the process media, for example steam, being ejected from the passageways 20b, 30b. This also results in two concentric steam shrouds instead of only one, to further offset the diffusion flame. Splitters and other optional features are often application-specific and designed and manufactured accordingly, using 3D printing technology for example.

When utilised for nameless combustion, it is particularly desired that one or more oxidants or oxidant media to be injected into the reactor are pre-heated. In such a case, one or more of the passageways 10, 20a-d, 30a-d can be used to pass the process media at elevated temperatures, which then transfer heat to the one or more passageways 10, 20a-d, 30a-d that carry the oxidant. This allows a safe and contained environment for the pre-heating of the oxidant. The device therefore acts as a self-contained heat exchanger for the oxidant media. In relation to this functionality, the design preferably includes two or more of the passageways that are parallel and adjacent to each other for a substantial portion of the length of the nozzle 100. This allows the nozzle to act as a heat exchanger between process media of respective passageways.

Notably, an external shell, casing or, jacket of the nozzle 100 can still be cooled to ensure that ash melting and other such factors do not prevail. For instance, this cooling can be done by passing coolant media through some of the passageways 10, 20a-d, 30a-d, especially those further away from the centre of the nozzle.

In one embodiment, the nozzle device may comprise eductor means or eductor features. For example, one or more passageways in the nozzle may comprise a built-in Venturi feature or small drilled hole on the side to allow entry of gases or fluids; this enables utilising a small amount of steam or nitrogen to draw hot process gases through the passageways in the nozzle. The incorporation of eductor means or features can be provided by designing and manufacturing the nozzle device using 3D printing technology.

The above features provide a means of heating of the oxidant flow using the process gases, while maintaining low nozzle shell temperature or helping to reduce the temperature around the nozzle.

One or more of the plurality of the passageways 10, 20a-d, 30a-d of the nozzle 100 may be utilised to inject solids such as catalytic media or bed media such as sand. This is most effective locally since the temperatures achieved can be much higher than the bulk temperature, improving the efficiency of the reaction. Additionally, a class of catalysts in common use in the oil and gas sectors or the gasification sector (such as olivine), which are designed to operate in reducing environments but require constant regeneration by being subjected to an oxidising environment, can be injected in this manner as the local conditions around the nozzle tip 130 are oxidising, allowing local regeneration. This favourably reduces greatly the need for separate regeneration processes, improving process economics.

The nozzle device may comprise means for attaching to a manifold outside the reactor into which the nozzle injects process media. In the embodiment as illustrated in FIGS. 1a and 2b, this attaching means comprises a connector ring 140, positioned at the far side of the nozzle device away from the nozzle tip 130; this ring 140 is used with a compression type fitting head that allows mating a ceramic to a metallic manifold.

The high-temperature injection apparatus can further comprise a nozzle casing. For example, the nozzle 100 as described in the above embodiments can be disposed inside the nozzle casing. It is appreciated that the apparatus can be manufactured so that the nozzle can be readily removed from the nozzle casing. The nozzle casing may be designed for the incorporation of auxiliary features and equipment therein. This allows, as mentioned above, a range of important support functions to be reliably carried out in addition to the core functionality of a high-temperature nozzle device.

In one example, a water-cooled camera housing within the nozzle casing can be included, with a quartz face to permit visual observation of the interior of the reactor. In another example, safety detection equipment including infrared, spark ignition sources, pilot lights (for safety purposes during part load operations) can be installed in the device housing. In yet another example, the device can be equipped with a dedicated passage for gas sampling off-takes for various functions including FID (flame ionization detector), NDIR (non-dispersive infrared), or chromatography. The design allows for the sample probe to be cooled with variable penetration.

Preferably, the material of the high-temperature injection apparatus, in particular the nozzle 100, comprises advance ceramics such as silicon carbide (SiC). It is now possible to manufacture a complex device such as the above-disclosed high-temperature multiphase injection apparatus, with its associated desirable qualities, using advanced ceramics in particular SiC or SiC-based variants to very high tolerances using 3D printing. 3D printing techniques allows state-of-the-art precision in terms of the functional details to be created and realised in the design and final product. For example, 3D printing allows the freedom to build any internal or external nozzle shape as appropriate to house the aforementioned items such as flame detection instrumentation, for instance in “eyelets” built into the nozzle. Preferably, the device is manufactured as a single casting, making it particularly reliable for industrial service.

By using SiC as a material, in a further example, temperature measurement can be carried out using a non-invasive probe built into the nozzle, due to the high thermal conductivity of SiC.

The current arrangement is also designed with a view to present a single injection device operable to perform a very broad range of process functions which are not conventionally achievable using currently available injection systems; it has a significant potential as a retrofit device for existing reactor systems, such as waste gasification systems and reactors in the petrochemical industry, to improve their performances and their process economics.

It is herein further disclosed a method of injecting media into a reactor at high temperature and/or high pressure. First and second media can be simultaneously injected from a first and a second passageway of a nozzle device, respectively, preferably at an angle to each other, and wherein the first and second passageways are isolated from each other. The media can be a fluid, gas, solid or any mixture thereof.

It is appreciated that the present invention is not to be limited by the above embodiments, and that many variations are within the scope of the appended claims. The various embodiments as described may be combined if necessary and appropriate. The drawings serve as exemplary illustrations of the invention only, to aid understanding of the invention. For example, the number, positions and shapes of passageways may be different from those examples illustrated in the drawings.

1. A high-temperature injection apparatus, comprising:
a nozzle; and
a plurality of passageways in the nozzle;
wherein the plurality of passageways comprises:
a primary passageway; and
at least one secondary passageway.

2. The apparatus of claim 1, wherein the primary passageway and/or the at least one secondary passageway are operable to inject a fluid, gas or solid.

3. The apparatus of, claim 1 wherein the primary passageway is operable to inject a fluid, gas or solid and the at least one secondary passageway is operable to inject a different fluid, gas or solid simultaneously.

4. The apparatus of claim 1, wherein the nozzle has a longitudinal axis, and the at least one secondary passageway is operable to inject a fluid, gas or solid at an angle to the longitudinal axis of the nozzle.

5. The apparatus of claim 1, wherein the plurality of passageways comprise a plurality of secondary passageways arranged about the primary passageway.

6. The apparatus of claim 1, wherein the fluid, gas or solid comprises at least one of: steam, nitrogen, an oxidant, oxidant media, a catalyst, catalytic media, bed media, sand, and a coolant.

7. The apparatus of claim 5, wherein the plurality of secondary passageways are arranged as a series of concentric or annular passageways around the primary passageway.

8. The apparatus of claim 7, wherein the primary passageway is a central passageway aligned with the longitudinal axis.

9. The apparatus of claim 8, wherein each of the plurality of secondary passageways is operable to inject the fluid, gas or solid at an inward angle with respect to the primary passageway.

10. The apparatus of claim 5, wherein the primary passageway and at least one of the plurality of secondary passageways are isolated from each other.

11. The apparatus of claim 5, wherein a first of the plurality of the secondary passageways and a second of the plurality of the secondary passageways are isolated from each other.

12. The apparatus of claim 5, wherein at least one secondary passageway is adjacent and parallel to the primary passageway or another secondary passageway along a portion of the length of the nozzle.

13. The apparatus of claim 1, wherein the material of the nozzle comprises advanced ceramics.

14. The apparatus of claim 13, wherein the material of the nozzle comprises silicon carbide (SiC) and/or SiC-based variants.

15. The apparatus of claim 1, wherein the device is operable to function in a reducing environment and/or an oxidising environment.

16. The apparatus of claim 1, wherein the nozzle is disposed in a nozzle casing.

17. The apparatus of claim 16, wherein the nozzle casing comprises auxiliary equipment.

18. The apparatus of claim 1, further comprising a dedicated passageway for gas sampling.

19. The apparatus of claim 1, further comprising eductor means.

20. A high-temperature multiphase injection nozzle device for use in a reactor, comprising first and second passageways, wherein at least one passageway is operable to inject solid media into the reactor.

21. The nozzle device of claim 20, wherein the solid media is carried in a fluid.

22. An injection nozzle and heat exchanger device, comprising:
a first passageway operable to transport a first fluid, gas or solid, and
a second passageway operable to transport a second fluid, gas or solid,
wherein the first and second passageways are substantially parallel and adjacent to each other so as to allow heat exchange between the first and second fluid, gas or solid, and
wherein the first and second passageways are operable to inject the first and second fluid, gas or solid, respectively, simultaneously in a predetermined direction.

23. A method of injecting media into a reactor at high temperature and high pressure, comprising:
injecting a first media from a first passageway of a nozzle device;
injecting simultaneously a second media from a second passageway of the nozzle device isolated from the first passageway,
wherein each of the first and second media comprises a fluid, gas or solid.

24. The method of claim 23, wherein the first media and the second media are injected at an angle relative to each other.

25. The method of claim 23, further comprising, prior to injection:
transferring heat between the first media in the first passageway and the second media in the second passageway, wherein the first and second passageways are adjacent and parallel to each other for a portion of the length of the nozzle device.

26. The method of claim 23, wherein:
the injection of the first media and the injection of the second media are performed at a local temperature greater than 1000° C., more preferably greater than 2500° C.

27. The method of claim 23, further comprising:
shrouding the first media with the second media, or cooling an external shell of the nozzle device.

28. A method of manufacturing the device of claim 1, using 3D printing.

29. A method of manufacturing the device of claim 1, using material comprising silicon carbide (SiC) and/or SiC-based variants.
